(19) United States
(12) Patent Application Publication
(10) Pub. No.: US 2020/0347948 A1
(43) Pub. Date: Nov. 5, 2020

(54) FILLING VALVE

(71) Applicant: FEDERAL MFG. LLC, Milwaukee, WI (US)

(72) Inventors: Cezary Mroz, Elkhorn, WI (US); Alexandru Berceanu, Quebec (CA)

(21) Appl. No.: 16/854,074

(22) Filed: Apr. 21, 2020

Related U.S. Application Data
(60) Provisional application No. 62/840,604, filed on Apr. 30, 2019.

(51) Int. Cl. F16K 21/00; B67D 7/36

(52) U.S. Cl. CPC F16K 21/00; B67D 7/36

(57) ABSTRACT

A valve for use in filling containers includes a valve flange, nozzle assembly and valve sleeve. The valve flange defines a first through passage. The nozzle assembly includes a nozzle head having a liquid fill outlet and air vent outlet below the valve flange and leading to a vent tube. The valve sleeve defines a second through passage and is movable between a lowered valve closed position and a raised valve open position. The valve sleeve including a first portion positioned for sliding movement within the first through passage and a second portion positioned below the valve flange and configured for sealingly closing both the liquid fill outlet and the air vent outlet when the valve sleeve is in the lowered valve closed position. The nozzle head is formed of a non-metal material. A valve may also be mated to the vent tube by a captive retaining clip.

### TECHNICAL FIELD

This application relates generally to filling valves comprising a filling nozzle used to fill containers such as bottles or jugs and, more specifically, to a filling nozzle having a non-metal, molded nozzle head and lacking an independent sealing ring. Also provided is a filling valve held in place by a captive clip.

### BACKGROUND

Filling nozzles are used in bottling systems that deliver bottles or other containers along a conveyance path and then beneath the filling nozzle so that liquid can be delivered into the bottles. In one known nozzle type, the nozzle head of the filling nozzle is constructed of metal and comprises a sealing O-ring to provide a seal between a lower extent of the valve and the nozzle head when the valve is in the closed position. Unfortunately, failure of the O-ring can result in contamination of the filled bottle, for example, when broken pieces of the O-ring fall into the filled bottle, thus requiring recall of the batch. In addition, the filling valve assembly is typically retained by a snap ring. However, failure of this snap ring can also result in contamination of the filled bottle, for example, when broken pieces of the clip fall into the filled bottle, thus requiring recall of the batch.

It would be desirable to provide a filling valve where the nozzle head is formed of a non-metal sealing material, such as silicone, and therefore, eliminating the need for a sealing O-ring. It would also be desirable for the clip retaining the filling valve to be captured to prevent contamination of the filled bottle if failure of the clip occurs.

### SUMMARY

In one aspect, a valve for use in filling containers includes a valve flange, a nozzle assembly and a valve sleeve. The valve flange defines a first through passage. The nozzle assembly includes a nozzle head defining at least one liquid fill outlet and at least one air vent inlet, the air vent inlet connected to a vent tube that passes upward through the first through passage, the nozzle head spaced below the valve flange. The valve sleeve defines a second through passage, and includes a first portion positioned for sliding movement within the first through passage as the valve sleeve moves between a lowered valve closed position and a raised valve open position. The valve sleeve includes a second portion positioned below the valve flange and configured for sealingly mating with the nozzle head to close both the liquid fill outlet and the air vent outlet when the valve sleeve is in the lowered valve closed position. The second through passage is in communication with the liquid fill outlet of the nozzle head so that liquid can pass downward along the first through passage, into and along the second through passage and to and out of the liquid fill outlet when the valve sleeve is in the raised valve open position. The valve sleeve has a biasing member to cause the valve sleeve to move downward from the raised valve open position to the lowered valve closed position. The nozzle head of the nozzle assembly is formed of a non-metal sealable material and molded onto the distal end of the vent tube, eliminating the need for an O-ring to provide a seal between a lower extent of the valve and the nozzle head.

In another aspect, a valve for use in filling containers includes a valve flange, nozzle assembly and valve sleeve. The valve flange defines a first through passage. The nozzle assembly includes a liquid fill outlet and air vent inlet below the valve flange. The valve sleeve defines a second through passage and is movable between a lowered valve closed position and a raised valve open position. The valve sleeve including a first portion positioned for sliding movement within the first through passage and a second portion positioned below the valve flange and configured for sealingly closing both the liquid fill outlet and the air vent inlet when the valve sleeve is in the lowered valve closed position. The filling valve, comprising the valve flange, nozzle assembly, and valve sleeve, is secured to a medial portion of the vent tube by a clip that is captively held in place at the interface of the filling valve and a liquid hopper atop the valve.

In a further aspect, a method of operating a filling valve includes: utilizing a valve sleeve disposed partially within a valve flange for movement between a lowered valve closed position and a raised valve open position; moving a container upward into contact with the valve so that the movement of the container causes the valve flange to move from the lowered valve closed position to the raised valve open position; and moving the container downward away from the valve so that a biasing member acts on the valve sleeve to move the valve sleeve from the raised valve open position to the lowered valve closed position.

### BRIEF DESCRIPTION OF THE DRAWINGS

FIGS. 1A-1B show one embodiment of a filling valve in closed and open positions, respectively;

FIGS. 2A-2C show the nozzle head of the filling valve in different perspectives;

FIGS. 3A-3B show retention of the filling valve to the vent tube via a captively held clip (FIG. 3B) and in an expanded view (FIG. 3A); and

FIGS. 4A-4B show an exterior view of one embodiment of the filling valve, the liquid hopper, and a bottle in a lowered valve closed position (FIG. 4A) and a raised valve open position (FIG. 4B).

### DETAILED DESCRIPTION

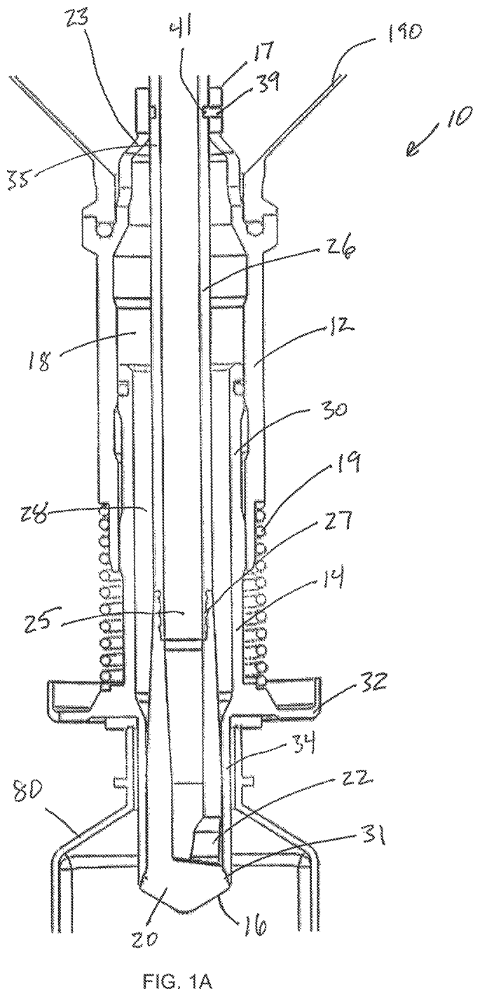

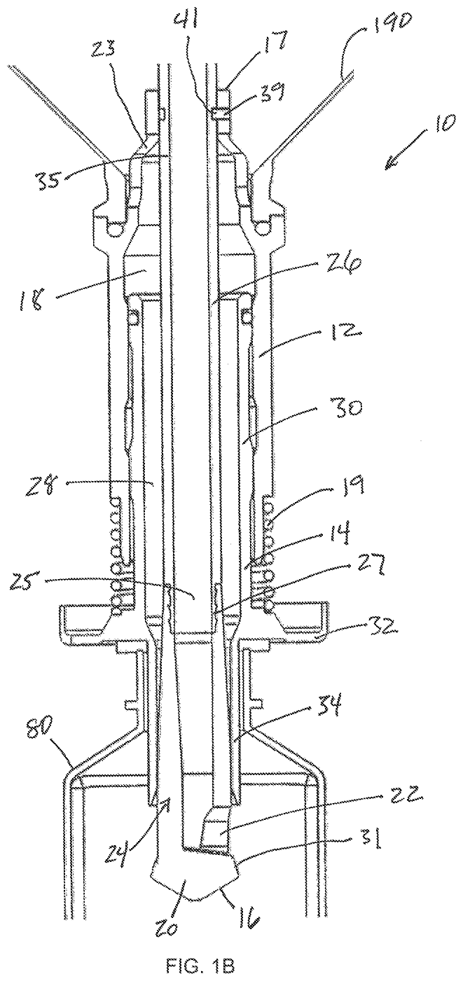

One embodiment of a filling valve 10 shown in FIGS. 1A-1B includes a valve flange 12, a valve sleeve 14 and a nozzle assembly 16. The valve flange defines a through passage 18. The nozzle assembly 16 includes a nozzle head 20 defining at least one liquid fill outlet 24 and at least one air vent inlet 22. The air vent inlet 22 connects to a vent tube 26 that passes upward through the passage 18. The nozzle head 20 is spaced below the valve flange 12.

The valve sleeve 14 defines a through passage 28 that is aligned with and partially within the passage 18. The valve sleeve includes an upper portion 30 positioned for sliding movement within the through passage 18 as the valve sleeve moves between a lowered valve closed position (per FIG. 1A) and a raised valve open position (per FIG. 1B). The valve sleeve 14 includes a lower portion 32 positioned below the valve flange 12 and configured for sealingly mating with the nozzle head 20 to close both the liquid fill outlet 24 and the air vent inlet 22 when the valve sleeve is in the raised valve closed position. In particular, the lower portion 32 of the valve sleeve includes a lower cylindrical extent 34 that engages the nozzle head 20 for the sealing purpose, as described below. Additionally, and in contrast to prior designs, the through passages 18 and 28 are concentric with the vent tube 26 disposed medially, which simplifies the design and reduces cost of production.

As indicated, the through passage 28 is in fluid communication with the liquid fill outlet 24 of the nozzle head so that liquid can pass downward along the through passage 18, into and along the through passage 28 and to and out of the liquid fill outlet 24 when the valve sleeve is in the raised valve open position, as reflected in FIG. 1B. As the liquid is flowing into a container, air within the container escapes by passing upward through the air vent inlet 22 and then up the vent tube 26, where the vent tube 26 extends up through a liquid hopper 190 and above the liquid level (not shown) in the liquid hopper 190.

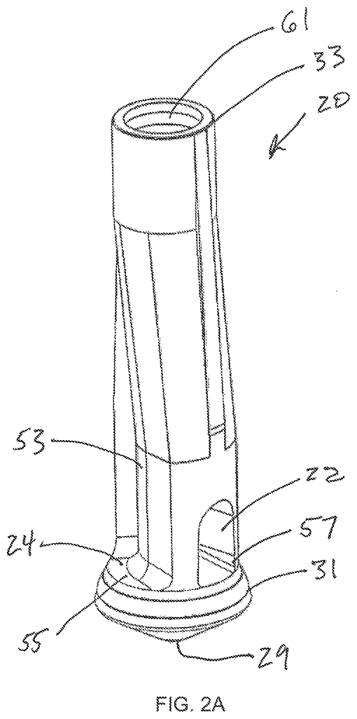

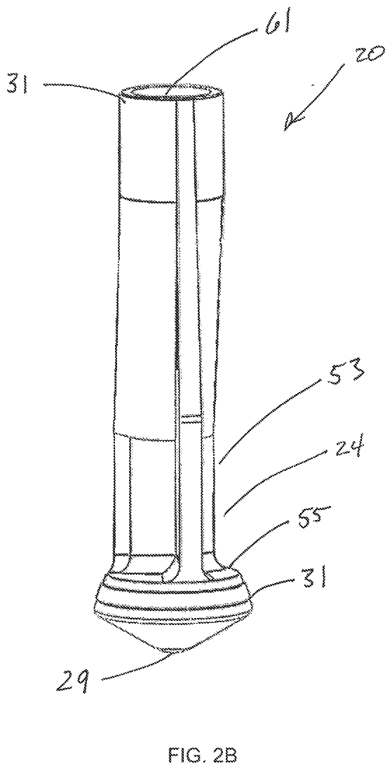

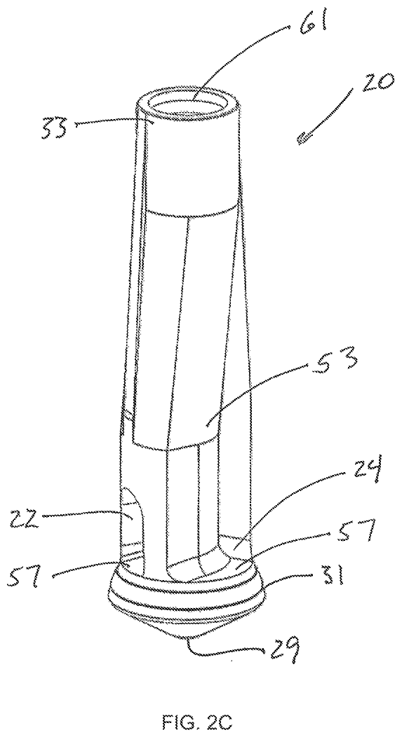

Notably, the nozzle head 20 of the nozzle head assembly 16 is formed of a non-metal material and molded onto a distal end 25 of the vent tube 26 (e.g., overmolded). In one embodiment, the nozzle head is formed of an elastomer such as silicone, or any suitable material which provides a seal, and is molded directly onto the distal end 25 of the vent tube 26 at the nozzle head/vent tube interface 27. By forming the nozzle head of a sealable, non-metal material and molding the nozzle head 20 onto the vent tube 26, a separate sealing ring, such as an O-ring, is not needed. This design eliminates the issue of a broken O-ring from potentially falling into the liquid-filled bottle, which then requires recall of the batch. As shown in isolation in FIGS. 2A-C, and in one embodiment, the nozzle head 20 comprises air vent inlet 22 and liquid fill outlet 24, and having a distal tip 29, a sealing area 31 comprising a downward and outward projection which sealingly engages the lower cylindrical extent 34 of the lower portion 32 of the valve sleeve 14, and a proximal end 33. In various embodiments, the nozzle head 20 is formed of more than one non-metallic material, for example, the sealing area 31 may be a different material than the rest of the nozzle head. In one embodiment, the sealing area 31 is silicone and the remaining portion of the nozzle head 20 is urethane. As described, the proximal end 33 of the nozzle head 20 is molded directly onto the distal end 25 of the vent tube 26 at the nozzle head/vent tube interface 27. As shown, the liquid fill outlet 24 comprises a fluid flow indent 53 along a first side portion of the nozzle head 20 and a fluid flow ledge 55 positioned above sealing area 31. As also shown, the air vent inlet 22 comprises a vertical aperture 57 positioned on a second side portion of the nozzle head 20, and which is in fluid communication with a central aperture 61 of the nozzle head 20, which in turn is in fluid communication with the vent tube 26.

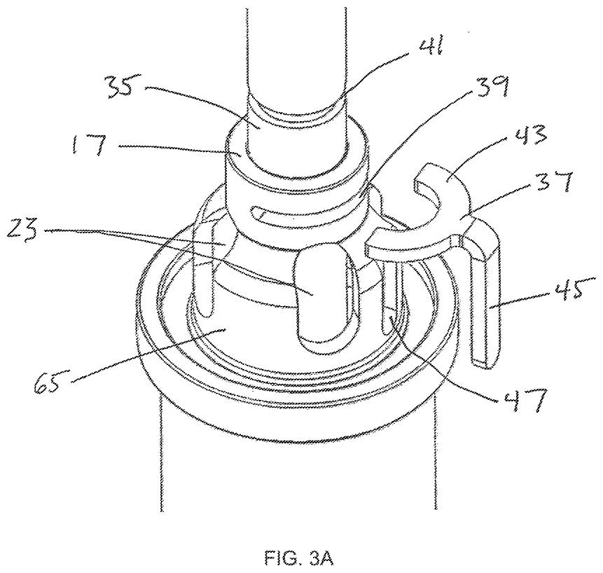

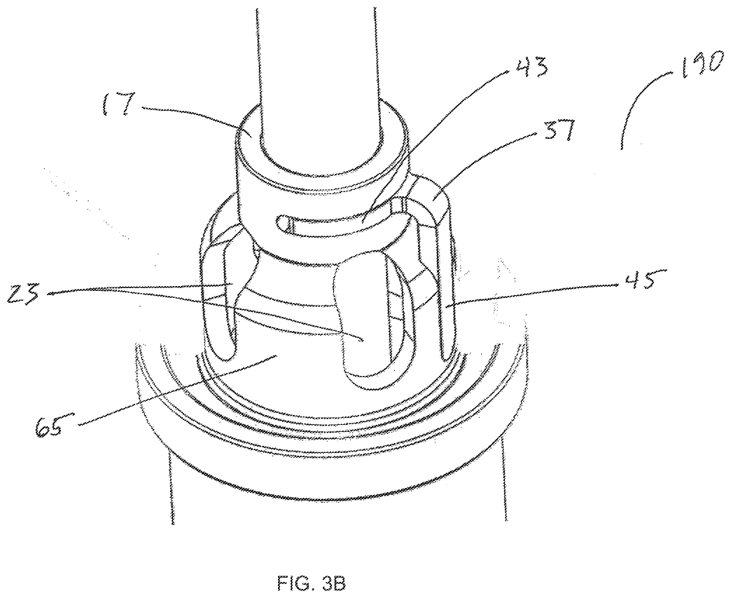

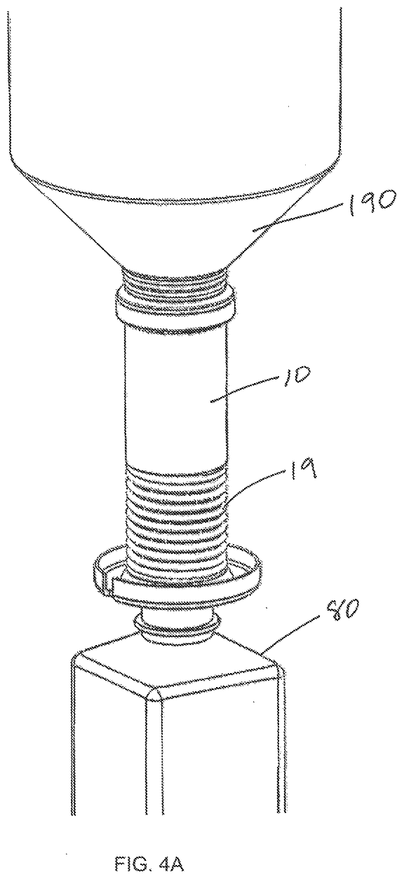

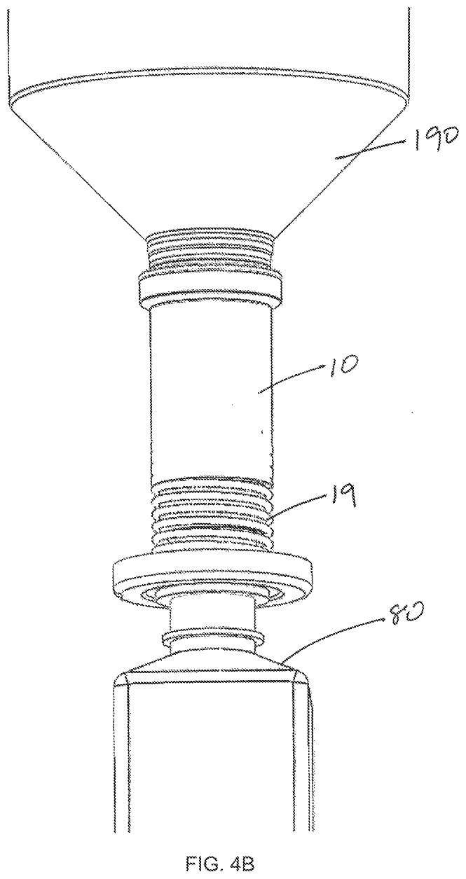

In another aspect, and as shown in FIGS. 3A-3B, the top 17 of the filling valve 10 is secured to a medial portion 35 of the vent tube 26 by a retaining clip 37 that is captively held in place at the interface of the filling valve 10 and a liquid hopper (not shown) (see FIG. 3B) atop the filling valve 10. More specifically, the filing valve 10 includes an upper dome 65 below the top 17 of the filling valve, and retaining clip 37 contains a vertical portion 45 which inserts within a vertical portion retention slot 47 in the upper dome 65 of the filling valve 10, and a horizontal semi-circular portion which inserts through retention slot 39 of the top 17 of the filling valve 10 and engages retention slot 41 in the medial portion 35 of the filling tube 26. The captively held retaining clip 37 provides the advantage of being retained, and therefore, eliminating the possibility of falling into the liquid filled bottle if the retaining clip 37 fails or breaks. Also shown in FIGS. 3A-3B are the fluid apertures 23 in the upper dome 65, which allow fluid to flow down from the liquid hopper 190 and into through passages 18 and 28, as described above. FIGS. 4A-4B show an external view of the liquid hopper 190 mated to the filling valve 10, which is in contact with a container 80, in a lowered valve closed position (per FIG. 4A) and a raised valve open position (per FIG. 4B).

By way of example, a filling machine may include a plurality of the valves 10, each valve mounted with its valve flange fixed to the machine and its nozzle assembly having a fixed position relative to the valve flange. The valve sleeve of each valve is biased to the closed position by a bias member 19, as described above, and is slidable upward to the open position by a container 80 to be filled by the valve. The container 80 may be moved upward by a lift plate spaced below the valve and forming part of the conveying system (not shown). By way of example, the valves could be arranged linearly in sequence or about an arcuate or other curved path, or some combination of the two.

It is to be clearly understood that the above description is intended by way of illustration and example only, is not intended to be taken by way of limitation, and that other changes and modifications are possible. For example, as an alternative to overmolding the nozzle head onto the end of the vent tube, the nozzle head could be molded as an independent piece and then connected to the distal end (e.g., nozzle head formed with internal threads that engage external threads of the end of the vent tube, or nozzle head formed to slide axially onto the end of the vent tube with a snap-fit retention onto the end of the vent tube).

What is claimed is:

1. A valve for use in filling containers, comprising:
a valve flange defining a first through passage;
a nozzle assembly including a nozzle head defining at least one liquid fill outlet and at least one air vent inlet, the air vent inlet connected to a vent tube that passes upward through the first through passage, the nozzle head spaced below the valve flange;
a valve sleeve defining a second through passage, the valve sleeve including a first portion positioned for sliding movement within the first through passage as the valve sleeve moves between a lowered valve closed position and a raised valve open position, the valve sleeve including a second portion positioned below the valve flange and including a lower cylindrical extent configured for sealingly mating with the nozzle head to close both the liquid fill outlet and the air vent inlet when the valve sleeve is in the lowered valve closed position, the second through passage in communication with the liquid fill outlet of the nozzle head so that liquid can pass downward along the first through passage, into and along the second through passage and to and out of the liquid fill outlet when the valve sleeve is in the raised valve open position;
wherein the nozzle head is formed of a non-metal material and is connected to a distal end of the vent tube at a nozzle head/vent tube interface.

2. The valve of claim 1 wherein the nozzle head is molded onto the distal end of the vent tube via an overmolding process.

3. The valve of claim 2, wherein the nozzle head is formed of an elastomer.

4. The valve of claim 3, wherein the elastomer is silicone, urethane, or combination thereof.

5. The valve of claim 1, wherein the nozzle head comprises a sealing area which sealingly mates with the lower cylindrical extent of the valve flange in the closed position without a separate sealing O-ring.

6. The valve of claim 5, wherein the sealing area of the nozzle head is formed from a different non-metal material than the nozzle head.

7. The valve of claim 1, wherein the liquid fill outlet of the nozzle head comprises a fluid flow indent positioned along a first side portion of the nozzle head, and a fluid flow ledge positioned above a sealing area of the nozzle head.

8. The valve of claim 7, wherein the air vent inlet of the nozzle head comprises a vertical aperture positioned on a second side of the nozzle head, where the vertical aperture is in fluid communication with a central aperture of the nozzle head, and the central aperture is in fluid communication with the vent tube.

9. The valve of claim 8, wherein, in the raised valve open position, liquid flows into and along the second through passage, along the fluid flow indent, over the fluid flow ledge, and out of the liquid fill outlet.

10. The valve of claim 9, wherein, in the raised valve open position, air travels into the vertical aperture, then substantially vertically through the central aperture, and then vertically up the vent tube.

11. The valve of claim 5, wherein the sealing area of the nozzle head comprises a downward and outward projection which sealingly engages the lower cylindrical extent in the closed position.

12. The valve of claim 1, wherein the first and the second through passages are concentric, and the vent tube is disposed medially in the first and second through passages.

13. A valve for use in filling containers, comprising:
a valve flange defining a first through passage;
a nozzle assembly including a nozzle head defining at least one liquid fill outlet and at least one air vent inlet, the air vent outlet connected to a vent tube that passes upward through the first through passage, the nozzle head spaced below the valve flange;
a valve sleeve defining a second through passage, the valve sleeve including a first portion positioned for sliding movement within the first through passage as the valve sleeve moves between a lowered valve closed position and a raised valve open position, the valve sleeve including a second portion positioned below the valve flange and configured for sealingly mating with the nozzle head to close both the liquid fill outlet and the air vent inlet when the valve sleeve is in the lowered valve closed position, the second through passage in communication with the liquid fill outlet of the nozzle head so that liquid can pass downward along the first through passage, into and along the second through passage and to and out of the liquid fill outlet when the valve sleeve is in the raised valve open position;
wherein the valve is secured to the vent tube by a captive retaining clip.

14. The valve of claim 13, wherein the captive retaining clip is held in place at the interface of the valve and a liquid hopper positioned above the valve.

15. The valve of claim 13, wherein the captive retaining clip comprises a vertical portion which inserts within a vertical portion retention slot on an upper dome top portion of the valve.

16. The valve of claim 13, wherein the captive retaining clip comprises a horizontal semi-circular portion which inserts through a retention slot on the top of the filling valve and engages a retention slot in a medial portion of the filling tube.

17. A filling machine including a plurality of valves according to claim 1, each valve mounted with the valve flange fixed to the machine.

18. A filling machine including a plurality of valves according to claim 13, each valve mounted with the valve flange fixed to the machine.

19. A method of operating a filling valve of claim 1, the method comprising:
moving a container upward into contact with the valve so that the movement of the container causes the valve flange to move from the lowered valve closed position to the raised valve open position; and
moving the container downward away from the valve so that a biasing member acts on the valve sleeve to move the valve sleeve from the raised valve open position to the lowered valve closed position.

20. A method of operating a filling valve of claim 13, the method comprising:
moving a container upward into contact with the valve so that the movement of the container causes the valve flange to move from the lowered valve closed position to the raised valve open position; and
moving the container downward away from the valve so that a biasing member acts on the valve sleeve to move the valve sleeve from the raised valve open position to the lowered valve closed position.
